(19) United States
(12) Patent Application Publication
(10) Pub. No.: US 2014/0307164 A1
(43) Pub. Date: Oct. 16, 2014

(54) METHOD AND DEVICE FOR SIGNAL CONCATENATION

(71) Applicant: Global Vision System Co., Ltd., Taipei (TW)

(72) Inventor: Chien Liang CHEN, Taipei (TW)

(73) Assignee: Global Vision System Co., Ltd., Taipei (TW)

(21) Appl. No.: 13/896,499

(22) Filed: May 17, 2013

(30) Foreign Application Priority Data
Apr. 12, 2013 (TW) 102113047

(51) Int. Cl. H04N 5/265; H04N 5/44

(52) U.S. Cl. CPC H04N 5/265; H04N 5/44
USPC 348/441

(57) ABSTRACT

The present invention discloses a method for signal concatenation. The method inputs signals from other signal device to a first signal device and outputs the signals from the first signal device after processed by the first signal device, comprises the steps of: establishing a connection between the first signal device and the other signal device; inputting the signals outputting from the other signal device to the first signal device; processing the input signals by the first signal device; and outputting the processed signals to an external device by the first signal device.

### BACKGROUND OF THE INVENTION

1. Field of the invention

The present invention relates to a method and device for signal concatenation, especially relates to a method and device that can concatenate multiple signals so as to integrate the signals from different signal sources.

2. Description of the prior art

A conventional content providing device or signal providing device, such as an analog TV signal set-top box (STB), a digital TV signal STB, a DVD player, or a Blu-ray player, etc. at home, has its own output interface. These output interfaces often connected to a corresponding input interface of a display at home via a wired connection, such as VGA, DVI, HDMI, Composite Video, Separate Video, or Component Video interconnects, so as to transmit the provided contents, such as analog/digital TV, video or audio signals to the display for presentation. A user must choose the input interface of the display manually via a remote controller so as to make the display show the contents desired by the user.

For example, the Blu-ray player is connected to a display through a first HDMI interconnects, the analog TV signal STB is connected to the display through an composite video interconnects, and the digital TV signal STB is connected to the display through a second HDMI interconnects. If the user want to watch contents provided by the Blu-ray player, the analog TV signal STB, or the digital TV signal STB, he or she must switch input interface of the display between the first HDMI interconnects, the composite video interconnects, or the second HDMI interconnects, respectively. However, switching between the input interfaces is inconvenient to the user.

Besides, each of the content or signal providing devices has its own signal modulation method and hardware. It is too difficult to integrate all content or signal providing device into one device, or make one single device to support every content or signal source.

### SUMMARY OF THE INVENTION

In view of the deficiencies of the prior-art techniques, the object of the present invention is to provide a method and device for signal concatenation so as to concatenate multiple signals from different signal sources and integrate those signals into one single output signal, and to provide a convenience of preventing the user from switching between multiple input interfaces of display.

According the one object of the present invention, provides a method for signal concatenation, the method inputting signals from other signal device to a first signal device and outputting the signals from the first signal device after processed by the first signal device, comprising the steps of: establishing a connection between the first signal device and the other signal device; inputting the signals outputting from the other signal device to the first signal device; processing the input signals by the first signal device; and outputting the processed signals to an external device by the first signal device.

According to one aspect of the present invention, the other signal device may be one or a plurality of signal device.

According to another aspect of the present invention, the first signal device may process the input signals based on a software method including a command of a user, a predetermined configuration or a combination thereof.

According to another aspect of the present invention, the connection between the first signal device and the other signal device may be a wired connection, a wireless connection, or a combination thereof; the wired connection may be DVI, HDMI, or DisplayPort interconnects, and the wireless connection may be Wireless HDMI interconnects.

According to another aspect of the present invention, the processed signal may include signals from the other signal device, the first signal device, or a combination thereof.

According to another aspect of the present invention, the external device may be a display device.

According the another object of the present invention, provides a signal device, receiving input signals from other signal device, processing the input signals, and outputting the processed signals through an output interface, comprising: an input interface, receiving the input signals from the other signal device; a processing chip, coupling to the input interface, and processing the input signals from the input interface; and an output interface, coupling to the processing chip, and outputting the processed signals to an external device.

According to one aspect of the present invention, the other signal device may be one or a plurality of signal device.

According to another aspect of the present invention, the signal device may process the input signals based on a software method including a command of a user, a predetermined configuration or a combination thereof.

According to another aspect of the present invention, the input interface or the output interface may be DVI, HDMI, DisplayPort or Wireless HDMI.

According to another aspect of the present invention, the processed signal may include signals from the other signal device, the signal device, or a combination thereof.

According to another aspect of the present invention, the external device may be a display device.

In view of the above, the present invention may have one or more of the following advantages:

1. The present invention can concatenate signals or multiple signals from different signal sources and integrate those signals into one single output signal.

2. The present invention can provide a convenience of preventing the user from switching between multiple input interfaces of display.

3. The present invention can satisfy user's need for E-commerce transaction while watching the contents.

### BRIEF DESCRIPTION OF THE DRAWINGS

FIG. 1 is a block diagram showing a signal device of the present invention;

FIG. 2 is a flow chart showing steps of a method for signal concatenation of the present invention;

FIG. 3 is a block diagram showing a first embodiment of the present invention;

FIG. 4 is a flow chart showing a flow of online shopping operations of the first embodiment; and

FIG. 5 is a block diagram showing a second embodiment of the present invention.

### REFERENCE NUMERALS

1 Signal device
122 Input interface
124 Input interface
126 Input interface
14 Processing chip
16 Output interface
18 Receiver
2 STB
3 Surveillance camera
4 DVD player
5 External device
52 Shopping message
54 TV signal screen
542 Accessory
56 Monitor screen

### DETAILED DESCRIPTION OF THE PREFERRED EMBODIMENT

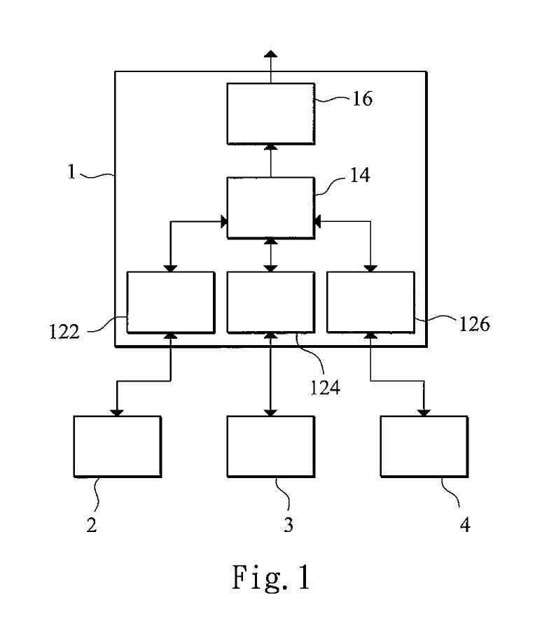

FIG. 1 is a block diagram showing a signal device of the present invention. As shown in FIG. 1, the signal device 1 comprises input interfaces 122, 124, 126, a processing chip 14 and an output interface 16. In the embodiment, the input interfaces 122, 124, 126 and output interface 16 may use HDMI as an example, but should not be considered as using HDMI only. The input interface 122 is connected to a STB 2, the input interface 124 is connected to a surveillance camera 3, and the input interface 126 is connected to a DVD player 4.

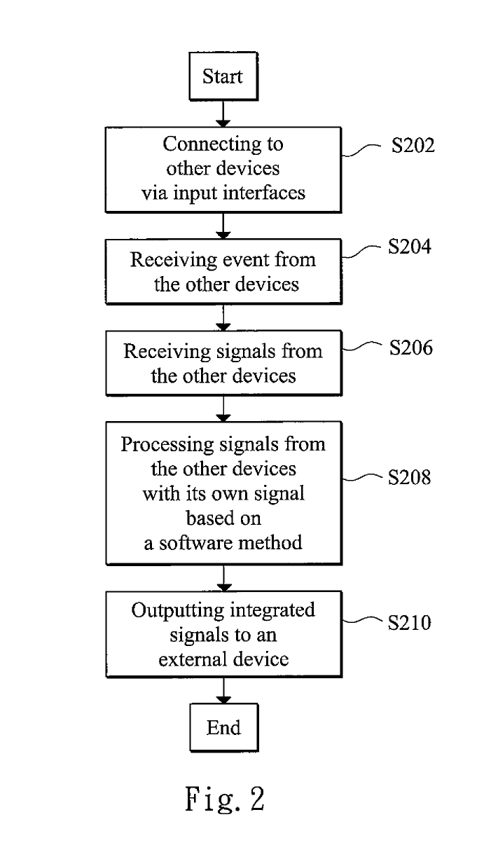

Referring now to FIG. 2 together with FIG. 1, FIG. 2 is a flow chart showing steps of a method for signal concatenation of the present invention. As shown in

FIG. 2, the signal device 1 may connect to the other signal devices, such as the STB 2, the surveillance camera 3 or DVD player 4 that provides signals, via the input interface 126 (step S202). After the signal device 1 has been connected to the other signal devices, the signal device 1 will receive an input event from the other signal devices (step S204), which means that the signal device 1 now is knowing that a connection between the signals device and the other signal device has been established. In the next step, the signal device 1 begins to receive signals provide by the other signal devices (step S206). The processing chip 14 will process the signals provided by the other signal devices with signals from the signal device 1 itself based on a software method, while the provided signals have been transmitted to the processing chip 14 through the interfaces 122, 124, 126 of the signal device 1 (step S208). After the process, the signal device 1 will output the integrated signals to an external device through the output interface 16 (step S210).

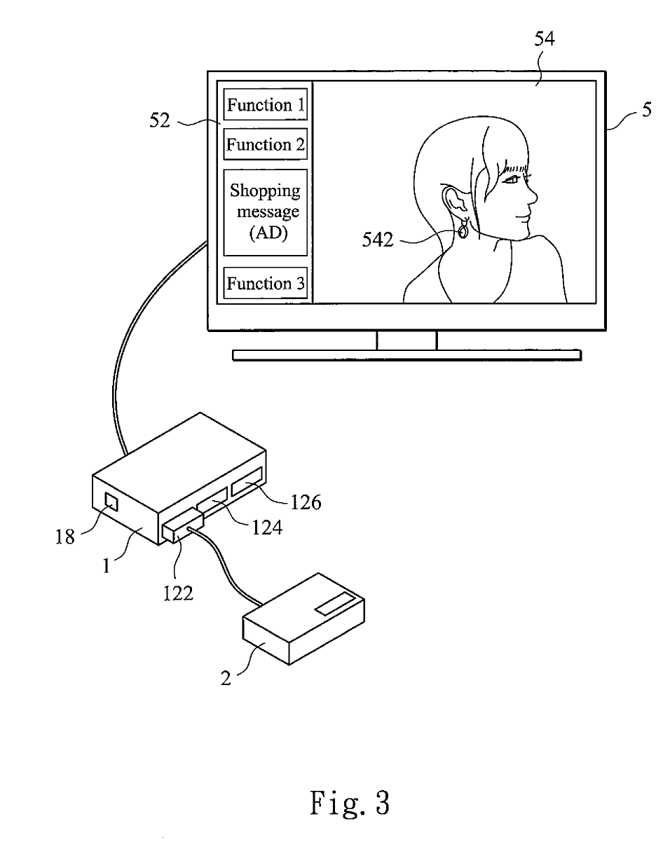

FIG. 3 is a block diagram showing a first embodiment of the present invention. As shown in FIG. 3, the signals from the STB 2 have been displayed as a TV signal screen on a external device 5 (e.g. a display) through the input interface 122 of the signal device 1. A new feature of the present invention is that, for example, if an accessory 542 worn by a character on the TV signal screen 54 is a predetermined event, a shopping message 52 will automatically prompted on the side of the TV signal screen. Through a receiver 18 on the signal device 1, the user may use a remote controller or other control device to select shopping message 52 prompted on the TV signal screen 54 to perform online shopping operations, if he or she likes the accessory 542.

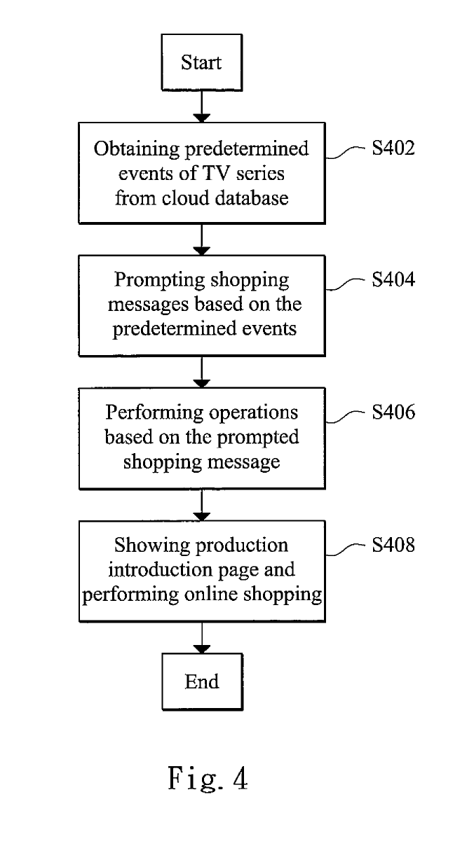

FIG. 4 is a flow chart showing a flow of online shopping operations of the first embodiment. As shown in FIG. 4, the signal device 1 may obtain predetermined events of TV series played by the user from a cloud database (step S402). The predetermined events includes products, such as clothes, shoes, or accessories, available for e-commerce transaction in the TV series. In the next step, the signal device 1 will prompt the shopping messages on the side of the TV signal screen based on the predetermined events (step S404). If the user is interested in the product shown in the shopping message, he or she may select “I want to buy it” option in the shopping message (step S406). Next, the signal device 1 will show a product introduction page so as the user may proceed to online shopping, during advertising times of the TV series, or the signal device 1 may pause the playing of the TV series and shows the product introduction page immediately (step S408).

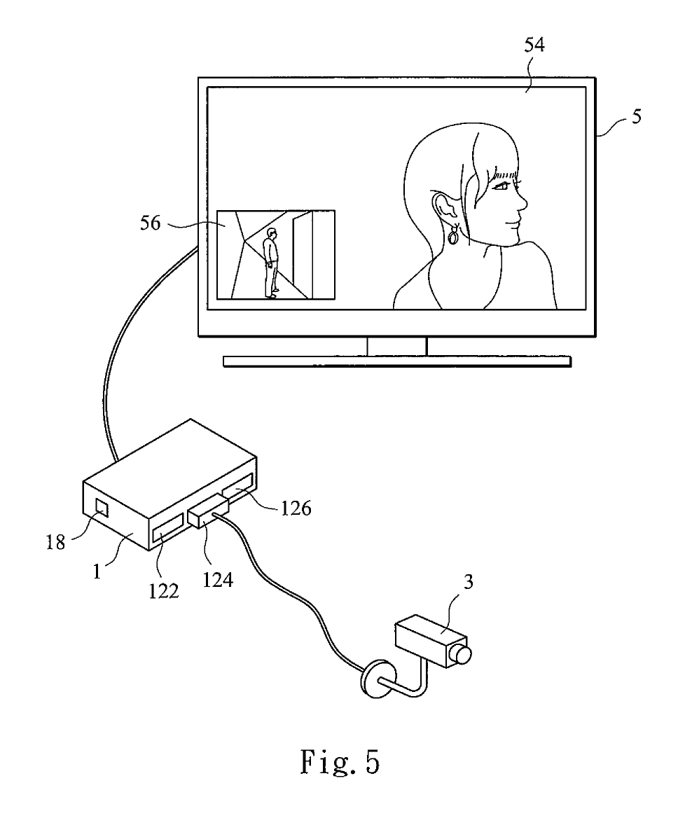

FIG. 5 is a block diagram showing a second embodiment of the present invention. As shown in FIG. 5, a surveillance camera is connected to the input interface 126 of the signal device. When detecting a specific event, such as movement of people or door bell pressing, the signal device 1 will display the monitor screen 56 beside the TV signal screen 54 automatically.

In addition to the above embodiments, the signals provided by the other signal device may be outputted directly to the external device 5 through the signal device 1, or may be superimposed on the screen of the signal device 1 in a manner of scaled, semi-transparent, or non-transparent (as described in the second embodiment). Besides, the signals from the signal device 1 itself may be superimposed on the screen of the signals provided by the other signal device in a manner of scaled, semi-transparent, or non-transparent.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A method for signal concatenation, the method comprising inputting signals from other signal device to a first signal device and outputting the signals from the first signal device after processed by the first signal device, further comprising the steps of:
establishing a connection between the first signal device and the other signal device;
inputting the signals outputting from the other signal device to the first signal device;
processing the input signals by the first signal device; and
outputting the processed signals to an external device by the first signal device,
wherein the external device is a display device.

2. The method as recited in claim 1, wherein the other signal device is one or a plurality of signal device.

3. The method as recited in claim 1, wherein the first signal device processes the input signals based on a software method.

4. The method as recited in claim 3, wherein the software method includes a command of a user, a predetermined configuration or a combination thereof.

5. The method as recited in claim 1, wherein the connection between the first signal device and the other signal device is a wired connection, a wireless connection, or a combination thereof.

6. The method as recited in claim 5, wherein the wired connection is DVI, HDMI, or DisplayPort interconnects.

7. The method as recited in claim 5, wherein the wireless connection is Wireless HDMI interconnects.

8. The method as recited in claim 1, wherein the processed signal includes signal from the other signal device, the first signal device, or a combination thereof.

9. (canceled)

10. A signal device, receiving input signals from other signal device, processing the input signals, and outputting the processed signals through an output interface, comprising:
an input interface, receiving the input signals from the other signal device;
a processing chip, coupling to the input interface, and processing the input signals from the input interface; and
an output interface, coupling to the processing chip, and outputting the processed signals to an external device,
wherein the external device is a display device.

11. The signal device as recited in claim 10, wherein the other signal device is one or a plurality of signal device.

12. The signal device as recited in claim 10, wherein the signal device processes the input signals based on a software method.

13. The signal device as recited in claim 12, wherein the software method includes a command of a user, a predetermined configuration or a combination thereof.

14. The signal device as recited in claim 10, wherein the input interface or the output interface is DVI, HDMI, DisplayPort or Wireless HDMI.

15. The signal device as recited in claim 10, the processed signal includes signals from the other signal device, the signal device, or a combination thereof.

16. (canceled)
